(19) United States
(12) Patent Application Publication
(10) Pub. No.: US 2022/0388382 A1
(43) Pub. Date: Dec. 8, 2022

(54) PEEL RESISTANT VEHICLE WINDOW WEATHER STRIP

(71) Applicant: Toyota Motor Engineering & Manufacturing North America, Inc., Plano, TX (US)

(72) Inventor: Paxton S. Williams, Milan, MI (US)

(21) Appl. No.: 17/342,336

(22) Filed: Jun. 8, 2021

(51) Int. Cl. B60J 10/277; B60J 10/21; B60J 10/70

(52) U.S. Cl. CPC B60J 10/277; B60J 10/21; B60J 10/70

(57) ABSTRACT

A peel resistant weather strip lining a window frame of a vehicle to create a seal between a window and the window frame. The strip may have a body having an opening and configured to receive the window. The strip may further have a first flap extending around the body and configured to engage an exterior surface of the window frame. The strip may further have a second flap extending around the body and configured to engage an interior surface of the window frame. The strip may further have a catcher extending out from the second flap. The catcher may make direct contact with the interior surface of the window frame to prevent the second flap from disengaging the interior surface of the window frame when the strip is unwantedly rotated while holding, opening, or closing a door of the vehicle.

### BACKGROUND

### 1. Field

The present disclosure is directed to vehicle window weather strips, particularly peel resistant vehicle window weather strips.

### 2. Description of the Related Art

Window weather strips of vehicles (e.g., a car, an SUV, a truck, a bus, a van, etc.) create a seal between a window and its window frame, thereby preventing wind, rain, snow, dust, dirt, mud, pests, etc. from entering the cabin or cockpit of a vehicle. Weather strips may be rubber or another plastic material and line the window frame. When opening and closing a door of a vehicle with the window down, drivers, passengers, or users may grab the door from the weather strip and apply a force on the weather strip, causing the weather strip to rotate and come out of engagement with the window frame in doing so. For example, when a vehicle is located in a tight space that is difficult for the user to maneuver when getting in and out of the vehicle such as a car carrier trailer, the user may grab the door from the weather strip and twist the weather strip. When the weather strip comes out of engagement with the window frame in a tucked state, the weather strip may be damaged. Rolling the window up when the weather strip is tucked may further cause damage to the weather strip due to forces applied by the window on the weather strip. When the weather strip is damaged, the seal between the window and the window frame may be impaired such that sound, wind, or unwanted debris may enter the cabin or cockpit of the vehicle. Further, the weather strip may have a wavy, uneven, and loose appearance that is undesirable. As a result, comfort, cleanliness, and visual aesthetic inside the cockpit of the vehicle may be impaired.

Hence, there is a need for a peel resistant weather strip for a vehicle window that prevents the weather strip from coming out of engagement with the window frame.

### SUMMARY

A peel resistant weather strip for a vehicle window is disclosed herein. The strip may have a body having an opening that receives the window. A first flap and a second flap may extend around the body. The first flap may engage an exterior surface of the window frame. The second flap may engage an interior surface of the window frame. There may be a catcher on the first flap and/or the second flap making direct contact with the exterior surface and/or the interior surface of the window frame, respectively. The catcher may engage the window frame when the strip is rotated towards the opening from inside or outside the vehicle to prevent the first flap and/or the second flap from disengaging the window frame.

A vehicle door assembly may have a window frame. The window frame may have a groove along at least one edge of the window frame. The vehicle door assembly may further have a strip. The strip may comprise a first material. The strip may be insertable into the groove. The strip may have at least one flap extending outside of the groove and engageable with the window frame. At least one of the at least one flap may have a catcher further engageable with the window frame to prevent the at least one flap from disengaging the window frame. The catcher may comprise a second material. The second material may have a hardness greater than a hardness of the first material.

The first material and the second material may be the same. The first material and the second material may be rubber. The second material may be metal.

The catcher may be adjacent to a ridge extending from the at least one flap to create a seal between the at least one flap and the window frame. The at least one flap may include an exterior flap and an interior flap. The interior flap may have the catcher. The strip may have an opening facing away from the groove of the window frame and configured to receive a slidable window.

A strip may be attachable around a window frame of a vehicle to create a seal between a window and the window frame. The strip may have a body having an opening. The strip may be configured to receive the window. The strip may have a first flap and a second flap. The first flap may extend around the body and be configured to engage an exterior surface of the window frame. The second flap may extend around the body and be configured to engage an interior surface of the window frame. The strip may have a catcher. The catcher may extend out from the second flap and make direct contact with the interior surface of the window frame to prevent the second flap from disengaging the interior surface of the window frame.

The strip may comprise a first material. The catcher may comprise a second material. The second material may have a hardness greater than a hardness of the first material. The first material and the second material may be the same. The first material and the second material may be rubber.

The first hook may have a first length and the second hook may have a second length. The second length may be greater than the first length. The strip may have a ridge adjacent to the catcher and extending from the second flap to create a seal between the second flap and the window frame.

A vehicle may have at least one door and a window frame on the at least one door. The window frame may have a groove along at least one edge of the window frame. The vehicle may further have a strip. The strip may comprise a first material. The strip may be insertable into the groove. The strip may have a body portion having an opening and two flaps extending from each side of the opening. The two flaps may be engageable with the window frame. At least one of the two flaps may have a catcher comprising a second material. The catcher may be configured to engage the at least one edge when the strip is rotated towards the opening to prevent the at least one of the two flaps from disengaging the window frame. The second material may have a hardness greater than a hardness of the first material. The vehicle may further have a window slidably attached to the at least one for having at least one edge receivable by the opening to create a seal between the window and the window frame.

The first material and the second material may be the same. The first material and the second material may be rubber. The second material may be metal.

The catcher may be adjacent to a ridge extending from the at least one of the two flaps to create a seal between the at least one of the two flaps and the window frame. The two flaps may each have a different length. The strip may be molded or extruded as a unitary structure.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1 illustrates a perspective view of a vehicle according to an aspect of the present disclosure;

FIG. 2 illustrates a door of the vehicle of FIG. 1 according to an aspect of the present disclosure;

FIG. 3 illustrates a cross-section of a window frame of the door of FIG. 2 according to an aspect of the present disclosure;

FIG. 4 illustrates the door of FIG. 2 being opened by holding the window frame according to an aspect of the present disclosure;

FIG. 5 illustrates a cross-section of the window frame of FIG. 4 having a weather strip having a catcher according to an aspect of the present disclosure; and

FIG. 6 illustrates a cross-section of the window frame of FIG. 4 having a weather strip without a catcher according to an aspect of the present disclosure.

### DETAILED DESCRIPTION

The assembly, apparatus, and vehicle described herein prevent a weather strip attached to a window frame of a door from unwantedly tucking inside the window frame, thereby preventing damage to the weather strip and maintaining the seal created by the weather strip between the window and the window frame. When opening, closing, or holding the vehicle door from the window frame and the weather strip, a user (e.g., driver and/or passenger (interchangeable when referring to autonomous or semi-autonomous vehicles)) may unintentionally twist their hand, thereby twisting the weather strip and causing it to tuck within a groove of the window frame. A catcher or a hook on a flap of the weather strip extending out of the window frame may prevent the weather strip from over-rotating to a point such that the flap gets tucked within the window frame. The catcher or may engage with an edge of the window frame and stop the rotation of the weather strip. The catcher may be made from a material harder than a material of the rest of the weather strip for added reinforcement.

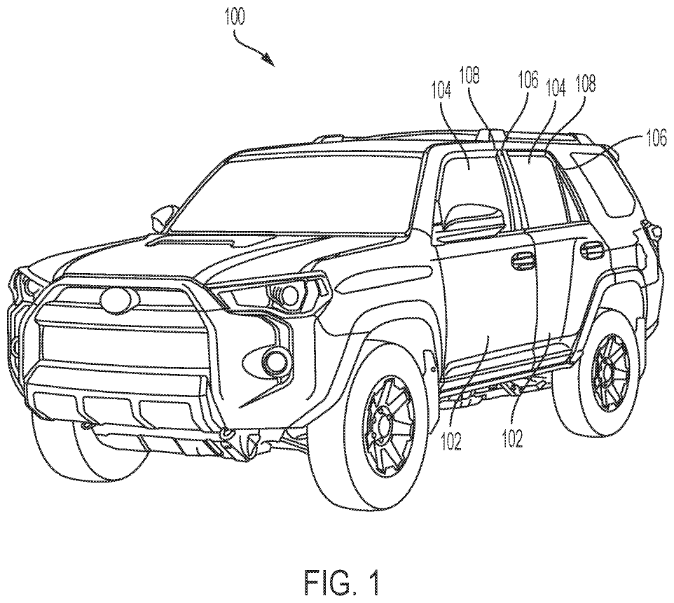

FIG. 1 illustrates a perspective view of a vehicle 100 according to an aspect of the present disclosure. The vehicle 100 is a conveyance capable of transporting a person, an object, or a permanently or temporarily affixed apparatus. The vehicle 100 may have an automatic or manual transmission. The vehicle 100 may be a self-propelled wheeled conveyance, such as a car, an SUV, a truck, a bus, a van, or other motor or battery driven vehicle. For example, the vehicle 100 may be an electric vehicle, a hybrid vehicle, a plug-in hybrid vehicle, a fuel cell vehicle, or any other type of vehicle that includes a motor/generator. FIG. 1A depicts an SUV by example. The vehicle 100 may be an autonomous or semi-autonomous vehicle having self-driving capabilities. The vehicle 100 may have doors 102 to enter and exit out of the vehicle 100. The doors may have windows 104 slidably engaged with window frames 106. The window frames 106 may have weather strips 108 to create a seal between the windows 104 and the window frames 106.

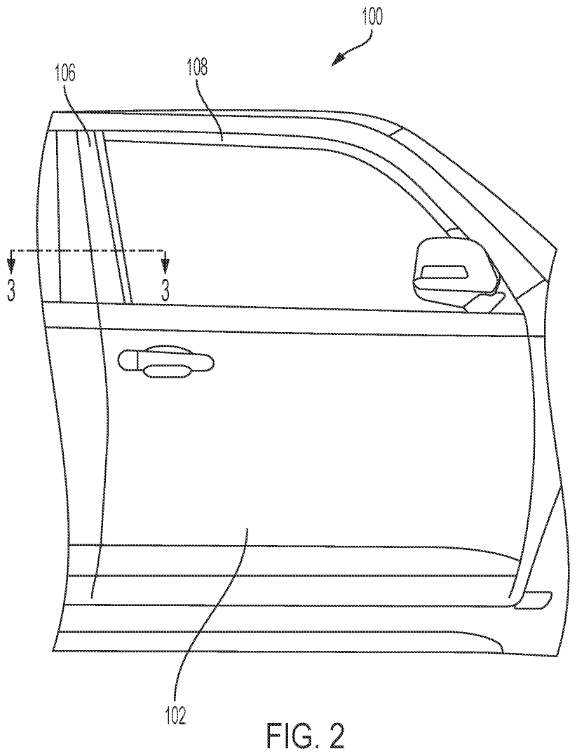

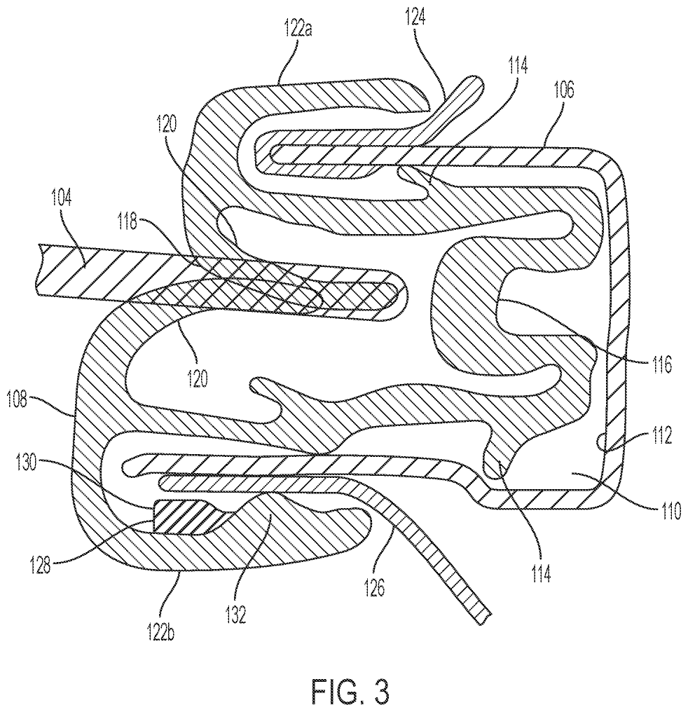

FIG. 2 illustrates a door 102 of the vehicle 100 according to an aspect of the present disclosure. The weather strip 108 of the window frame 106 may line the window frame 106 partially or entirely. The weather strips 108 may prevent debris (e.g., dirt, dust, mud, etc.), sound, and weather elements (e.g., rain, snow, wind, etc.) from entering inside the vehicle 100. The weather strips 108 may be molded or extruded from a polymer such as rubber or thermoplastic olefin (TPO). The window frame 106 may have a unitary weather strip 108 attachment or segments of weather strips 108 attached. Once attached to the window frame 106, the weather strip 108 may sit within the window frame 106 and partially extend out of the window frame 106 as shown in greater detail in FIG. 3.

FIG. 3 illustrates a cross-section of a window frame 106 of a door 102 (see FIG. 2) according to an aspect of the present disclosure. The window frame 106 may have a groove 110. The weather strip 108 may be partially inserted into the groove 110. The groove 110 may have a surface 112 in direct contact with the weather strip 108. The surface 112 may be uneven to provide added friction between the surface 112 and the weather strip 108. The weather strip 108 may have one or more protrusions 114 that engage with the surface 112. The protrusions 114 may further help retain the weather strip 108 within the groove 110 by engaging the surface 112. In some embodiments, the surface 112 may be flat and even. The weather strip 108 may have a distal bend 116. The distal bend 116 may allow the weather strip 108 to elastically collapse when entering the groove 110 to be inserted with ease and regain its shape once all the way in the groove 110.

The weather strip 108 may have an opening 118. The opening 118 may be formed by two internal flaps 120 facing each other. When the window 104 is slid up, the window 104 may enter and engage the opening 118, separating the internal flaps 120 by force. The internal flaps 120 may create a seal around the window 104. As the window 104 is slid down, the internal flaps 120 may begin to return to their original form and position and touch each other, thereby closing the opening 118.

The weather strip 108 may have one or more external flaps 122. The external flaps 122 may extend out of the groove 110 and curve around to make direct contact with the window frame 106. For example, a first external flap 122a or exterior flap may engage an exterior surface 124 of the window frame 106 and a second external flap 122b or interior flap may engage an interior surface 126 of the window frame 106 as shown in FIG. 3. The first external flap 122a and the second external flap 122b may have different lengths. For example, the second external flap 122b may have a greater length than the first external flap 122a. The greater length of the second external flap 122b may provide a greater tolerance to prevent tucking of the second external flap 122b inside the groove 110. The second external flap 122b may have a catcher 128. In some embodiments, the first external flap 122a may have a catcher 128. In some embodiments, both the first external flap 122a and the second external flap 122b may have a catcher 128.

The catcher 128 may prevent the external flaps 122 from disengaging the window frame 106 when the weather strip 108 is rotated towards the opening 118. For example, as shown in FIG. 3, second external flap 122b may have a catcher 128 that may prevent the external flap 122b from disengaging the interior surface 126 of the window frame 106. The catcher 128 may have a sharp corner 130 that may engage with the window frame 106 to prevent over-rotation of the weather strip 108. In some embodiments, the catcher 128 may be a hook. In some embodiments, the catcher 128 may have a rough surface or one or more protrusions in lieu or in addition to the sharp corner 130 to create friction against the window frame 106.

The catcher 128 may be made from the same mold shot or extrusion as the weather strip 108. In some embodiments, the catcher 128 may be made from a second mold shot or extrusion. In some embodiments, the catcher 128 may be adhered onto the weather strip 108 with a conventional adhesive such as glue. The catcher 128 may be made from a material having a hardness greater than that of the material of the rest of the weather strip 108. The catcher 128 having a greater hardness may provide additional reinforcement and durability to the catcher 128. Hence, the catcher 128 may retain its function with greater longevity.

The catcher 128 may be made from the same material (e.g., rubber, TPO, etc.) as the rest of the weather strip 108. However, the material of the catcher 128 may have a greater density to achieve a greater hardness. In some embodiments, the catcher 128 may be made from a material different than that of the rest of the weather strip 108, such as another polymer having a greater hardness. In some embodiments, the catcher 128 may have metal wires or fibers embedded within to achieve a greater hardness. In some embodiments, the catcher 128 may be entirely metal.

The external flaps 122 may have a ridge 132. The ridge 132 may create a seal between the external flaps 122 and the window frame 106. The seal may prevent debris (e.g., dirt, dust, mud, etc.), sound, and weather elements (e.g., rain, snow, wind, etc.) from entering inside the vehicle 100 through the groove 110. In some embodiments, only one external flap 122 may have a ridge 132. For example, the second external flap 122b may have a ridge 132 as shown in FIG. 3. The ridge 132 may be distal to the catcher 128. The ridge 132 may be directly adjacent to the catcher 128. In some embodiments, the catcher 128 may create a seal between the external flaps 122 and the window frame 106 in lieu of a ridge 132.

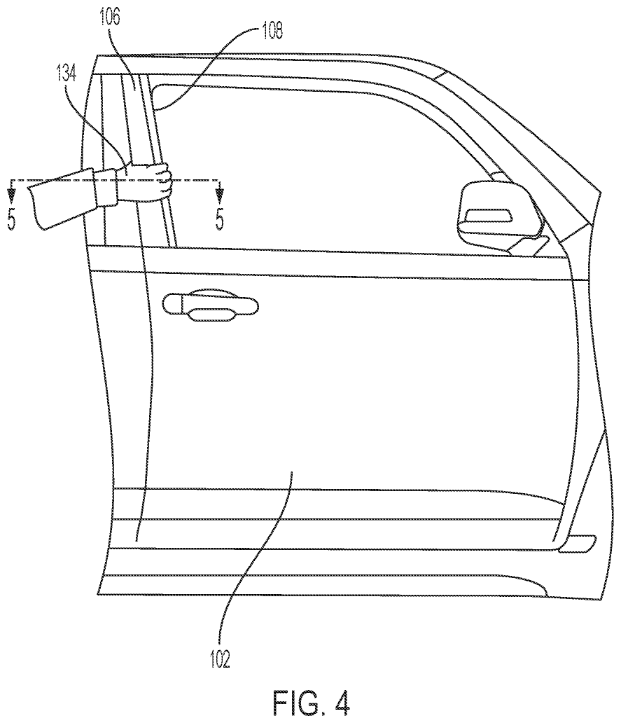

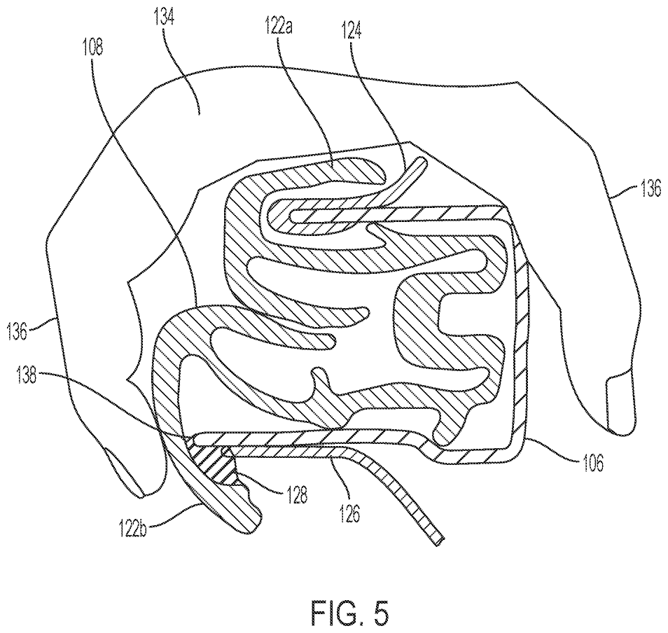

FIG. 4 illustrates the door 102 being opened by holding the window frame 106 according to an aspect of the present disclosure. The window 104 (see FIG. 3) may be rolled down partially or completely. The user may grab the window frame 106 by a hand 134 to open or close the door 102. In doing so, the user may rotate the weather strip 108 unwantedly. Particularly, the manner which the user is holding the window frame 106 in FIG. 4 may cause the second external flap 122b to disengage from the interior surface 126 of the window frame 106 as shown in greater detail in FIG. 5. In other examples, the user may hold the window frame 106 from an opposing direction, thereby causing the first external flap 122a (see FIG. 5) to disengage from the exterior surface 124 (see FIG. 5) of the window frame 106.

FIG. 5 illustrates a cross-section of the window frame 106 having the weather strip 108 with the catcher 128 according to an aspect of the present disclosure. The window 104 (see FIG. 3) may be rolled down partially or completely. The user may hold the window frame 106 from the outside of the vehicle 100 (see FIG. 1) to open the door 102 (see FIG. 4) such that the user's fingers 136 may wrap around the window frame 106. One or more of the fingers 136 may pull the second external flap 122b in rotating motion towards the user's hand 134. When the second external flap 122b is pulled as shown in FIG. 5, the catcher 128 may directly engage with an edge 138 of the window frame 106 to prevent the second external flap 122b from over-rotating and disengaging the interior surface 126 of the window frame 106. While in engagement, the catcher 128 may elastically deform to conform with the shape of the edge 138 to mitigate mechanical failure of the catcher 128.

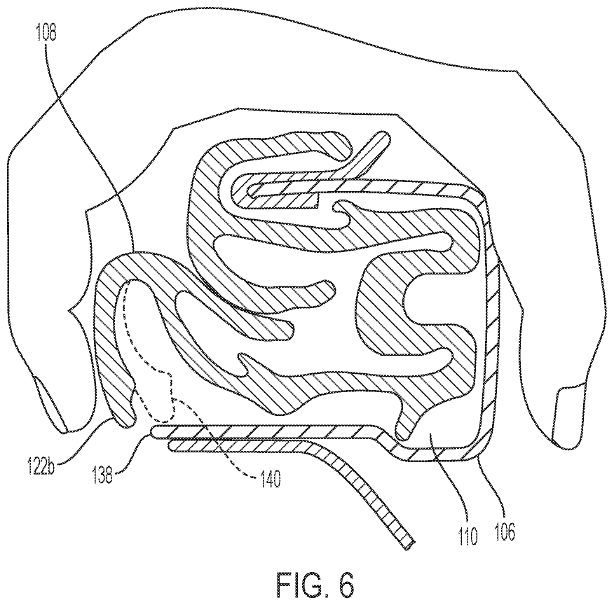

FIG. 6 illustrates a cross-section of the window frame 106 having a weather strip 108 without a catcher 128 (see FIG. 5) according to an aspect of the present disclosure. The user may hold the window frame 106 in the same manner as shown in FIG. 5. However, since no catcher 128 is present to directly engage with the edge 138 of the window frame 106, the second external flap 122b may over-rotate and disengage the interior surface 126 of the window frame 106. As shown by the dashed lines 140, the second external flap 122b may be tucked inside the groove 110 of the window frame 106. When the second external flap 122b is tucked inside the groove 110, the weather strip 108 may experience plastic deformation and be permanently damaged. Rolling the window 104 (see FIG. 3) up when the second external flap 122b is tucked may further cause damage to the weather strip 108 due to forces applied by the window 104 on the internal flaps 120 (see FIG. 3), which have less room to form the opening 118 (see FIG. 3). When the weather strip 108 is damaged, the seal between the window 104 and the window frame 106 may be impaired such that sound, wind, or unwanted debris may enter inside the vehicle 100 (see FIG. 1). Further, the weather strip 108 may have a wavy, uneven, and loose appearance that is undesirable.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A vehicle door assembly comprising:
a window frame having a groove extending along at least one edge of the window frame; and
a strip comprising a first material insertable into the groove, the strip having at least one flap extending outside of the groove and engageable with the window frame, at least one of the at least one flap having a catcher further engageable with the window frame to prevent the at least one flap from disengaging the window frame, the catcher comprising a second material having a hardness greater than a hardness of the first material.

2. The vehicle door assembly of claim 1, wherein the first material and the second material are the same.

3. The vehicle door assembly of claim 2, wherein the first material and the second material are rubber.

4. The vehicle door assembly of claim 1, wherein the second material is a metal.

5. The vehicle door assembly of claim 1, wherein the catcher is adjacent to a ridge extending from the at least one flap to create a seal between the at least one flap and the window frame.

6. The vehicle door assembly of claim 1, wherein the at least one flap includes an exterior flap and an interior flap, the interior flap having the catcher.

7. The vehicle door assembly of claim 1, wherein the strip has an opening facing away from the groove of the window frame and configured to receive a slidable window.

8. A strip attachable around a window frame of a vehicle to create a seal between a window and the window frame comprising:
a body having an opening and configured to receive the window;
a first flap extending around the body and configured to engage an exterior surface of the window frame;
a second flap extending around the body and configured to engage an interior surface of the window frame; and
a catcher extending out from the second flap and making direct contact with the interior surface of the window frame to prevent the second flap from disengaging the interior surface of the window frame.

9. The strip of claim 8, wherein the strip comprises a first material and the catcher comprises a second material, the second material having a hardness greater than a hardness of the first material.

10. The strip of claim 9, wherein the first material and the second material are the same.

11. The strip of claim 10, wherein the first material and the second material are rubber.

12. The strip of claim 8, wherein the first hook has a first length and the second hook has a second length, the second length being greater than the first length.

13. The strip of claim 8, further comprising a ridge adjacent to the catcher and extending from the second flap to create a seal between the second flap and the window frame.

14. A vehicle comprising:
at least one door;
a window frame on the at least one door, the window frame having a groove extending along at least one edge of the window frame;
a strip comprising a first material insertable into the groove, the strip having a body portion having an opening and two flaps extending from each side of the opening and engageable with the window frame, at least one of the two flaps having a catcher comprising a second material and configured to engage the at least one edge when the strip is rotated towards the opening to prevent the at least one of the two flaps from disengaging the window frame, the second material having a hardness greater than a hardness of the first material; and
a window slidably attached to the at least one door having at least one edge receivable by the opening to create a seal between the window and the window frame.

15. The vehicle of claim 14, wherein the first material and the second material are the same.

16. The vehicle of claim 15, wherein the first material and the second material are rubber.

17. The vehicle of claim 14, wherein the second material is a metal.

18. The vehicle of claim 14, wherein the catcher is adjacent to a ridge extending from the at least one of the two flaps to create a seal between the at least one of the two flaps and the window frame.

19. The vehicle of claim 14, wherein the two flaps each have a different length.

20. The vehicle of claim 14, wherein the strip is molded or extruded as a unitary structure.
